(19) United States
(12) Patent Application Publication
(10) Pub. No.: US 2003/0197117 A1
(43) Pub. Date: Oct. 23, 2003

(54) Method and apparatus for compensating a vector command to a galvanometer with light beam pointing error information

(76) Inventors: Jeffrey G. Knirck, Sunnyvale, CA (US); Paul A. Swanson, Cupertino, CA (US)

Correspondence Address: Jeff Knirck, 868 Jasmine Dr., Sunnyvale, CA, 94086, US

(21) Appl. No.: 10/125,881

(22) Filed: Apr. 22, 2002

(51) Int. Cl. H01J 3/14

(52) U.S. Cl. 250/234

(57) ABSTRACT

A means for compensating a vector command to one or more galvanometers, or other beam steering device, with pointing error information about the laser source is disclosed. The apparatus is to be used in galvanometer based vector writing or raster scanning system. The present invention measures the laser beam lateral and angular pointing errors, and or any target position error information, and modifies the vector command sent to the galvanometer head with the pointing error information in order to eliminate the laser pointing error from the resultant projected laser vector. The incoming laser beam is sampled to extract two dimensions of lateral error and two dimensions of angular error. The lateral error information from the incident beam or the target is directly added to the vector. The angular information must be multiplied by the optical path length from the error measurement point to the target to derive the effective lateral displacement due to the angular error.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

The present invention relates to laser vector writing, and more particularly, to compensating the commanded vector with measured laser beam pointing error information.

Two axis galvanometer heads for laser beam vector writing are common. They are used in conjunction with lasers of different types to project patterns of laser beam vectors onto various types of surfaces or targets. Such systems are used for applications ranging from visual displays for entertainment to machining, including etching characters or holes in manufactured parts. As the precision and accuracy requirements of the projected vectors increases, the various error sources become more important. One such error source is the lateral and angular pointing errors on the laser beam as it exits the laser head. Another, complementary, error source is any residual motion of the target that can be detected. These errors directly influence the pointing error of the projected vectors.

External laser beam stabilizers are available. They use up to four actuators to stabilize the laser beam. Using such a device in conjunction with a vector writing head in many cases is economically inefficient considering the stabilized beam is frequently redirected by two galvanometers. Additionally, the mechanical stability between the laser and the galvanometers can be costly to stabilize. A better approach would be to measure and combine laser beam pointing error information with the desired vector to command the two galvanometers to direct the laser beam where it should ultimately go. A new system is needed that simply tells the galvanometer head where to point the laser to produce the desired vector while accounting for point errors due to the laser beam or any intervening optics.

Basting et al U.S. Pat. No. 6,014,206 (January 2000) teaches about an “apparatus and method for stabilization of laser output beam characteristics by automatically adjusting the angular and lateral positions of the output beam”. Basting is differentiated from the present invention by both purpose and means. Basting uses multiple detectors and a “beam steering device” to stabilize the beam to a constant, which a vector writing galvanometer head could then redirect in accordance with the commanded vectors. As a consequence, Basting would require a total of six actuators, four for beam stabilization and two for beam writing. The present invention measures the beam pointing errors and then modifies the commanded vectors accordingly to produce new commanded vectors that will allow the vector writing galvanometer head to direct the laser beam where it should go.

Trepagnier U.S. Pat. No. 5,400,132 (March 1995) teaches about “methods of compensating for errors in a laser pointing device”. Trepagnier is differentiated from the present invention by both purpose and means. Trepagnier is concerned with improving static beam pointing inaccuracies caused by manufacturing tolerances inside the galvanometer vector writing head. Trepagnier recommends a technique involving “accurate angular alignment relationship to at least four fiducial points.” Trepagnier does make the point that sources of imprecision include “variations in the mounting of the laser or other beam-steering elements”.

### BRIEF SUMMARY OF THE INVENTION

The principal object of the present invention is to provide a means that simply tells the galvanometer head where to point the laser to produce the desired vector while accounting for point errors due to the laser beam or any intervening optics and environmental sources such as air currents and temperature, as well as target motion.

The present invention takes the form of a device that is physically located between a laser and a vector-writing galvanometer head or any beam steering device. The present invention measures the laser beam lateral and angular pointing errors and modifies the vector command sent to the galvanometer head by the pointing error information in order to eliminate the laser pointing error from the resultant projected laser vector. The present invention uses one or more optical sensors to determine the pointing errors of a laser beam by sampling a small fraction of the beam as the beam passes through to the beam steering head. Similarly, any measurable residual motion of the target can be used to compensate the vector command. An electronic processor is used to combine the original commanded vector with the measured pointing error information to produce a new commanded vector to the galvanometer or other beam steering head. The lateral error is directly added to the vector. The angular information must be multiplied by the optical path length from the error measurement point to the target to derive the effective lateral displacement due to the angular error.

The present invention would be ideal for use with very high precision vector writing or machining applications. The technique can be used for any number of degrees of freedom. For a single axis beam steering system a single laser beam lateral position sensor could be used. A second sensor could determine the angular error in the plane of interest. For a two-axis vector writing system, two dimensions of lateral position must be sensed. Two more sensors would provide the information to compensate for the pertinent angular errors.

Other objects, features and advantages of the present invention will become apparent from the following detailed description when taken in conjunction with the accompanying drawings.

### BRIEF DESCRIPTION OF THE SEVERAL VIEWS OF THE DRAWINGS

FIG. 1 is a block diagram of a vector writing system including the present invention between a laser and a set of galvanometers.

### DETAILED DESCRIPTION OF THE INVENTION

The present invention provides means to compensate for light beam pointing errors using the beam steering head in a vector writing application. The advantage is that the present invention will increase the accuracy of the beam steering system without adding the complexity and cost of additional positioning mechanisms, environmental controls and structural elements.

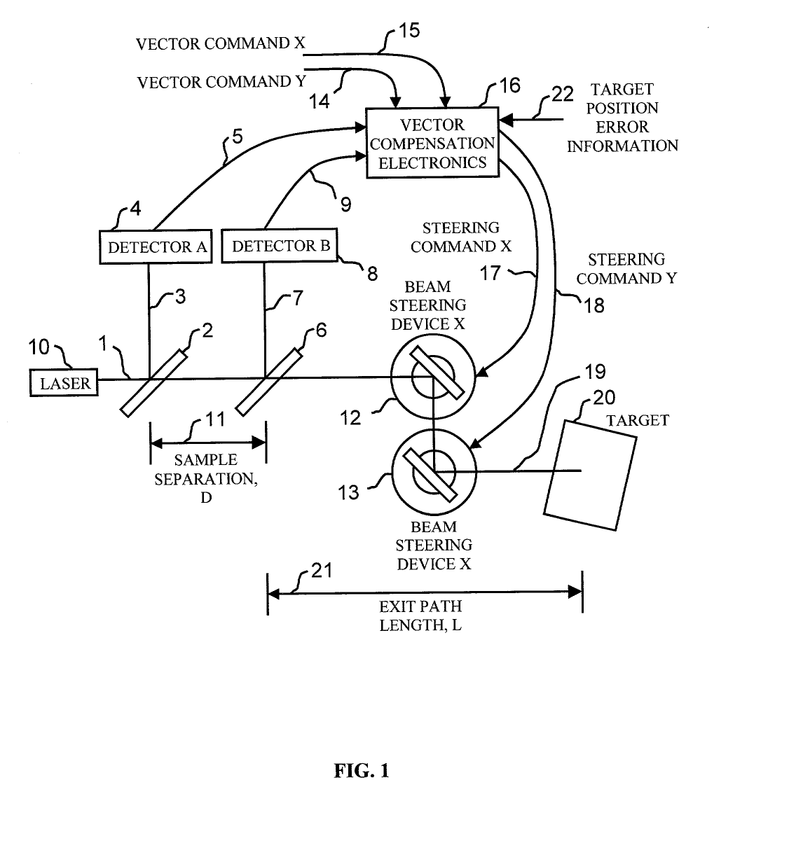

The present invention can be implemented in numerous variations of configuration and components. In any case the basic concept is the same. The function can be implemented in hardware or in software. FIG. 1 shows a block diagram of a vector writing system with the present invention included. Four axes of detection and two axes of correction are shown. Fewer or more axes of beam sensing or correction could be implemented.

FIG. 1 shows a Laser Light Source 10 producing an incident Laser Beam 1 that may include a beam pointing error. The beam pointing error may include lateral errors in X and Y, and or angular errors about the Z-axis. Where the Z-axis is the intended axis of light propagation. The Laser Beam is sampled by a first Beam Splitter 2, which directs a first Sampled Beam 3 to a first Detector A 4. For the vector writing system shown in FIG. 1, the first Detector A 4 would be a two-axis position detector to sense the beam lateral offsets in axes X and Y. Either a quadrant detector or a two axis position sensitive device (PSD) would be a good choice for the Detector. The sensed X, Y errors 5 from the first Detector A 4 are reported to the Vector Compensation Electronics 16. After passing through the first Beam Splitter 2, the Laser Beam 1 passes through a second Beam Splitter 7, which directs a second Sampled Beam 7 to a second Detector B 8. The second Detector B 8 is used to sense the lateral beam offsets in the same two axes that were sensed by the first Detector A 4. The sensed X, Y errors 9 from the second Detector B 8 are also reported to the Vector Compensation Electronics 16. Since some Sample Separation D 11 separates the beam splitters 2 & 6, the angular deviation of the Laser Beam can be deduced by the change in the lateral beam error reported by the two Detectors 4 & 8.

After sampling, the incident Laser Beam continues to the vector-writing head composed of Beam Steering Device X 12 and Beam Steering Device Y 13. The beam steering devices direct the Vectored Laser Beam 19 to the Target 20. Exit Path Length L 21 indicates the total optical path length from the second beam splitter, through the beam steering devices, to the target. The Vector Compensation Electronics 16 also receives the Vector Command X 14 and Vector Command Y 15 that were vector commands directed to the Beam Steering Device X 12 and Beam Steering Device Y 13, respectively. The Vector Compensation Electronics combines the Vector Commands with the sensed errors from Detectors A & B with the Vector Commands to produce a new Steering Command X 17 and new Steering Command Y 18. The X-axis information from Detectors A is added directly to the Vector Command X. The Y-axis information from Detectors A is added directly to the Vector Command Y. Additionally, any available X, Y Target Position Error Information 22 can also be directly added. This function can be used in a vector writing system to allow the relatively fast vector writing to happen on a target on a relatively slow stage while the stage is still moving.

Compensating for the angular error is a little more complicated. The Vector Compensation Electronics subtracts the sensed X, Y errors taken from the Detector A from the sensed X, Y errors taken from the Detector B to produce an X difference signal and a Y difference signal. These intermediate difference signals can be designated DeltaX and DeltaY, respectively. The sensed angular errors would be calculated as DeltaX/D and DeltaY/D, where D is the Sample Separation distance. These angular errors in X and Y would be compensated by adding DeltaX(L+D)/D directly to the Vector Command X and adding DeltaY(L+D)/D to the directly to the Vector Command Y, where L is the Exit Path Length. The Steering Command X 17 is the result of compensating the Vector Command X 15 with the lateral error in X and the angular component in X. The Steering Command Y 18 is the result of compensating the Vector Command Y 14 with the lateral error in Y and the angular component in Y. Once compensated, the Steering Commands should direct the Vectored Laser Beam 19 to the correct location on the Target 20, as if no beam pointing errors had existed.

In a vector writing system the present invention takes the form of a “black box” placed in the optical path between the laser and the beam steering head, and placed electrically between the vector command source and the galvanometer head. The beam splitter materials and optical coatings and the detectors will have to be compatible with the laser beam wavelength used. The angular compensation gain constant L associated with the Exit Path Length for a particular system will have to be programmed into the Vector Compensation Electronics. The various electronic gains and offsets in the Vector Compensation Electronics may have to be calibrated for each system to ensure maximum accuracy.

The above descriptions are illustrative and not restrictive. Many variations of the invention will become apparent to those skilled in the art upon review of this disclosure. Merely by way of example, the Vector Compensation Electronics can be implemented in analog or digital electronics or in a computer. The detectors could be single axis or multiple axes. The detectors could be quadrant cells or PSDs or cameras. The invention could be manufactured as a separated module or incorporated into a vector writing or raster scanning galvanometer head product. The present invention could be used in a system that includes a laser beam source and a galvanometer to point the beam, as depicted in FIG. 1, or it can be used in conjunction with any signal beam source or any beam pointing device. Different optical configurations including the use of a single beam splitter in the main optical path and a second beam splitter to secondarily sample the primary sampled beam. Note that this arrangement would allow the laser and the galvanometer to be in as dose proximity as possible and thus reducing adverse effects presented by mechanical or environmental disturbances.

The scope of the invention should therefore be determined not just with reference to the above description, but instead should be determined with reference to the appended claims along with their full scope of equivalents.

We claim:

1. A beam pointing error compensation apparatus, for use with a beam steering device, to compensate for beam pointing errors, comprising:
a beam sampling means to detect beam pointing error information of an incident beam; and
a means to compensate a command directed to a beam steering device with the beam pointing error information.

2. A beam pointing error compensation apparatus of claim 1 where:
the beam sampling means detects lateral and angular beam pointing errors.

3. A beam pointing error compensation method, for use with a beam steering device, to compensate for beam pointing errors of an incident beam, comprising the steps of:
detecting beam pointing error information of an incident beam; and
compensating a command directed to a beam steering device with the beam pointing error information.

4. A beam pointing error compensation method of claim 3 further comprising the step of:
using exit path length information to compensate for angular beam pointing errors.

5. A beam pointing error compensation method, for use with a beam steering device, to compensate for beam pointing errors, comprising the steps of:
detecting target position error information; and
compensating a command directed to a beam steering device with the target position error information.
